(19) United States
(12) Patent Application Publication
(10) Pub. No.: US 2025/0094398 A1
(43) Pub. Date: Mar. 20, 2025

(54) UNIFIED RDBMS FRAMEWORK FOR HYBRID VECTOR SEARCH ON DIFFERENT DATA TYPES VIA SQL AND NOSQL

(71) Applicant: Oracle International Corporation, Redwood Shores, CA (US)

(72) Inventors: Aleksandra Czarlinska, San Jose, CA (US); Saurabh Naresh Netravalkar, Foster City, CA (US); Denis B. Mukhin, Burlington, MA (US); Harichandan Roy, Amarillo, TX (US); Zhen Hua Liu, San Mateo, CA (US); Sebastian de la Hoz Luna, Zapopan (MX); Beda Christoph Hammerschmidt, Palo Alto, CA (US); George R. Krupka, Washington, DC (US); Bo Xia, Sunnyvale, CA (US); David Chih-Wei Jiang, Washington, DC (US)

(21) Appl. No.: 18/885,531

(22) Filed: Sep. 13, 2024

Related U.S. Application Data
(60) Provisional application No. 63/583,203, filed on Sep. 15, 2023.

(51) Int. Cl. G06F 16/22; G06F 16/93

(52) U.S. Cl. CPC G06F 16/2237; G06F 16/2282; G06F 16/93

(57) ABSTRACT

Techniques for a unified relational database framework for hybrid vector search are provided. In one technique, multiple documents are accessed and a vector table and a text table are generated. For each accessed document, data within the document is converted to plaintext, multiple chunks are generated based on the plaintext, an embedding model generates a vector for each of the chunks, the vectors are stored in the vector table along with a document identifier that identifies the accessed document, tokens are generated based on the plaintext, the tokens are stored in the text table along with the document identifier. Such processing may be performed in a database system in response to a single database statement to create a hybrid index. In response to receiving a hybrid query, a vector query and a text query are generated and executed and the respective results may be combined.

### BENEFIT CLAIM

This application claims the benefit under 35 U.S.C. § 119 (e) of U.S. Provisional Application No. 63/583,203, filed Sep. 15, 2023 by Czarlinska et al.

### TECHNICAL FIELD

The present disclosure relates generally to database systems and, more particularly to, presenting a single search interface to users to perform different types of searches.

### BACKGROUND

Traditionally, users of database systems have been provided search tools to initiate queries of data that is stored in relational tables. Such queries include keywords and/or other search criteria that data items must contain or satisfy in order to be returned as results of those queries. This keyword approach is traditional information retrieval.

With vector databases, users are able to perform semantic searches on documents for which embeddings are generated. To run a semantic search, users with documents (such as PDF/Word documents) must first transform the documents into vectors using a series of steps that are typically performed outside of the index and outside of the database system. Such transformation includes converting the documents into plaintext, chunking them into pieces, and converting them into vectors using a vector embedding model. For JSON (JavaScript Object Notation) documents where one or more fields need to be vectorized, users must provide explicit instructions to compute vectors for those fields and include those vectors back into the JSON to be indexed. At query time, the user either has access to a simple search API or to SQL, but not both.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example database system, in an embodiment;

FIG. 2 is a block diagram that depicts an example vector table that is produced by a vectorizer, in an embodiment;

FIG. 3 depicts examples of different final sets of results given a result set from performing a text search of an hybrid index and a result set from performing a vector search of the hybrid index, in an embodiment;

FIG. 4 depicts examples of different final sets of results given a result set from performing a text search of a hybrid index and a result set from performing a vector search of the hybrid index;

FIG. 5 is a flow diagram that depicts an example process for processing a hybrid query in an embodiment;

FIG. 6 is a block diagram that illustrates a computer system upon which an embodiment of the invention may be implemented;

FIG. 7 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

A system and method for a hybrid search on different data types are provided. In one technique, a database system constructs a single index that supports information retrieval search alongside vector similarity search and, optionally, alongside relational predicates. In a related technique, the database system supports chunk-level and document-level queries with one or more result-fusion and scoring methodologies. The single index may be queried through a single search API and accessed through a view.

Embodiments improve computer-related technology pertaining to searching in databases. A user is able to submit a single query, which is automatically translated into multiple queries, one for performing a semantic search and another for performing a text-based search. Also, embodiments reduce the consumption of computer resources, such as CPU and memory, by performing document intake and processing once for both vector database construction and text database construction. Further, with embodiments, users are not required to make use of complex and costly solutions involving owning RDBMS assets for relational search, owning separate assets for unstructured search, and owning separate, specialized vector database assets for vector similarity search. Embodiments reduces this complexity and cost by indexing all data items into a single hybrid index that can be searched with a single user query.

### System Overview

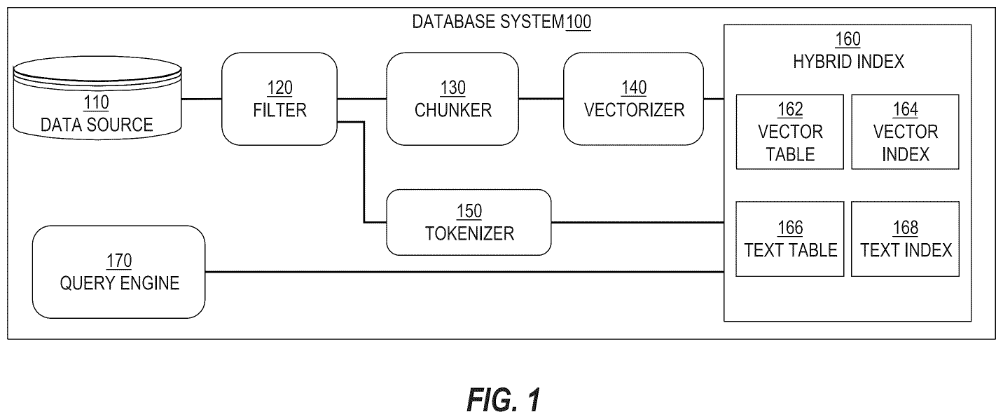

FIG. 1 is a block diagram that depicts an example database system 100, in an embodiment. Database system 100 may be a relational database management system (RDBMS) that stores and manages relational tables. Database system 100 comprises a data source 110, a filter 120, a chunker 130, a vectorizer 140, a tokenizer 150, a hybrid index 160, and a query engine 170. These components of database system 100 (except for query engine 170) comprise a single indexing pipeline that includes a “fork” or a split in the data flow, which is described herein. Filter 120, chunker 130, vectorizer 140, tokenizer 150, and query engine 170 may be implemented in software, hardware, or any combination of software and hardware.

Data source 110 comprises one or more types of data items, such as columns, files, and documents. A data item may be a JSON document, an XML document, textual data (e.g., VARCHAR2), and/or a BLOB (binary large object). Examples of other types of documents include PDFs, HTML, word processing documents, spreadsheet documents, and presentation/slide documents, each of which is encoded textual data.

Data source 110 may be a database, a file system, a network location, a directory, or a combination thereof. Data source 110 may be local or remote to database system 100. If remote, then the data items in data source 110 may have originated from another source, such as a remote source, and, therefore, may have been stored in data source 110 as the result of a data retrieval operation. For example, database system 100 receives a request to index data items, where the data items are stored remotely relative to database system 100 and, therefore, the request includes one or more references (e.g., uniform resource locators (URLs)) that database system 100 uses to request those data items. The request may be an HTTP request. In response, database system 100 receives the requested data items and stores those data items in data source 110.

In a related embodiment, a data item includes a reference to data that is to be indexed. For example, a JSON document may include, in one of the JSON objects in the JSON document, a reference, such as a URL. The reference points to a remote data source. The reference may point to textual data, image data, video data, or audio data. Thus, database system 100 (or a component thereof), when reading the data item, detects a reference, uses the reference to generate and send a request to another entity, receive a response from that entity, and perform zero or more operations on data within the response. Such operations may be performed by filter 120. Example operations include performing speech-to-text recognition on audio data (which may be part of video data) and optical character recognition (OCR) on image data, which also may be part of video data.

In an embodiment, data items in data source 110 are heterogenous, spanning different database columns (e.g., JSON, XML, text) and/or files of different types, such as PDF, Word, HTML, RAR, ZIP, etc. Additionally, some of the data items that are input to filter 120 may be read from one location (e.g., a database, a local directory, or a network) and some of the data items that are input to filter 120 may be read from another location.

### Index Creation Instructions

A user of database system 100 provides instructions to database system 100 on how to construct a hybrid index given a set of data items that will be ingesting into the indexing pipeline. The instructions may be in the form of a data definition language (DDL) statement, such as the following:
CREATE HYBRID VECTOR INDEX index_name ON table_name (column_name) PARAMETERS ( . . . );

In this example, the name of the hybrid index is “index_name,” the name of the table that stores the data items that are to be index is “table_name,” and the name of the column in which the data items are stored is “column_name.” Also in this example, the DDL statement includes a list of one or more parameters. Some parameters may be semantic-related parameters while other parameters may be text-related parameters.

Examples of semantic-related parameters include a name (or location) of an embedding model that is to be used to generate embeddings (or vectors) given a chunk of text, a chunking method (e.g., by word or by sentence), a type of vector index (e.g., inverted vector file (IVF) index or hierarchical navigatable small worlds (HNSW)), a distance function (e.g., cosine distance, dot distance, Euclidean distance, and Manhattan distance), vector index search accuracy (e.g., a scale between 0 and 100), whether to vector an entire JSON object/record, and one or more specific JSON fields (within a JSON object) to vectorize (if any). For each possible parameter, if no value is specified in the DDL statement, then a default value may be used.

Examples of text-related parameters include a data store, a filter type, a lexer, a sectioner, and a stoplist. The data store refers to how the document/text is obtained. The document/text may be obtained by file reference or URL. If there is no value for the data store parameter, then the text may be a column. The filter type refers to the extraction of text from rich content files, such as PDF. The lexer refers to how the text is to be tokenized. Several techniques for tokenizing may be supported. The sectioner refers to a process that records the sections of text, for example, by markup, such as <title>. The stoplist is a list of words to exclude from indexing, such as “the.”

### Filter

Filter 120 ingests a data item and outputs plaintext that is eventually input to chunker 130 and to tokenizer 150. In other words, the same plaintext that filter 120 outputs is transmitted to both chunker 130 and to tokenizer 150. If a data item is already in plaintext, then filter 120 passes the plaintext to chunker 130 and tokenizer 150. If a data item is not in plaintext, then filter 120 performs one or more operations on the data item to convert data within the data item to plaintext. For example, if a data item is a PDF document, then filter 120 extracts plaintext from the PDF document. As another example, if a data item is a zipped file, then filter 120 performs an unzip operation on the zipped file to output data which may be in plaintext or may need to be converted to plaintext.

In an embodiment, filter 120 processes different types of data items in order to generate plaintext. For example, filter 120 performs a different set of one or more operations depending on the type of data item. As a specific example, filter 120 performs a first set of operations on JSON documents and a second set of operations on BLOB documents. The first set of operations may involve detecting and extracting plaintext from a JSON document. The second set of operations may involve decoding the encoded data within a BLOB document, resulting in plaintext.

In an embodiment, filter 120 processes a JSON document in one of multiple ways. For example, in a first way, filter 120 accepts a JSON document that already has a vector. Filter 120 may be notified where the vector is located or may detect a vector while analyzing the JSON document. For example, metadata of a JSON object within a JSON document may indicate that a certain field includes vector data. Thus, filter 120 reads this metadata and identifies, within the JSON document, each instance of the certain field in order to extract the vector in each instance.

In a second way, filter 120 identifies which fields in a JSON document have text data that are to be converted into vectors, and passes the contents of those fields to chunker 130 or directly to vectorizer 140. The identification of such fields may be based on a value of a particular parameter in a hybrid index creation database statement.

In a third way, filter 120 identifies which JSON fields contain references to remote data sources, retrieves data from those remote data sources using the references, performs any needed conversions on the retrieved data (i.e., in order to obtain plaintext), and causes vectorizer 140 to generate one or more embeddings based on the plaintext.

In a fourth way, filter 120 causes an entire JSON document to be passed to chunker 130 and the chunks to be sent to vectorizer 140 in order to generate embeddings based on those chunks.

### Chunker

Chunker 130 generates a chunk of text for each portion of multiple portions of a set of plaintext received from filter 120. Such “chunking” is necessary because many sets of plaintext have a text size that is larger than a context window of an embedding model that generates embeddings for input text. Therefore, a set of plaintext may be divided into chunks and each chunk is “vectorized.”

Chunking may be performed by selecting a threshold number of characters or number of bytes that may fit into a context window of an embedding model. To prevent splitting up words or sentences, chunker 130 may take into account words or sentences when performing a chunking operation. For example, if a threshold number of characters would cause the last sentence to be split so that a resulting chunk would not end with a period, then chunker 130 identifies the end of the previous sentence and only select text up to that point when generating a chunk. Therefore, each chunk and each subsequent chunk may begin with a complete sentence. Such chunking may help resulting vectors to have less noisy data.

If different embedding models are used to vectorize chunks over time and the different embedding models have different context windows, then chunker 130 may take into account those different context windows when generating chunks based on a text data item. Thus, chunker 130 generates relatively small chunks for an embedding model with a relatively small context window and larger chunks for an embedding model with a larger context window.

As described herein, a database statement that instructs database system 100 to create a hybrid index may specify an embedding model to use. If the embedding model is not supported by database system 100, then an error may be presented. Alternatively, database system 100 may transmit chunks to a remote vectorize service that generates vectors based on chunks and return those vectors to database system 100. If the database statement that instructs database system 100 to create a hybrid index does not specify an embedding model to use, then vectorizer may select a default embedding model.

### Vectorizer

Vectorizer 140 generates an embedding for each chunk that is input to vectorizer 140. For example, if a document is divided into one hundred chunks and those chunks are passed to vectorizer 140 as input, then vectorizer 140 will generate one hundred embeddings for the document, one embedding for each chunk. An embedding is also referred to as a vector. A vector may be stored different in one of multiple ways. For example, a dense vector (where there are relatively few, if any, dimension that have a zero value) will contain the entire embedding, whereas a sparse vector will exclude dimension values that have a zero value. Also, a vector may be stored in a vector object that contains not only the vector, but also metadata about the vector, such as a number of dimensions, an indicator of the dimension format, and one or more next version values that reference other versions of the vector, if other versions exists. Other versions of a vector may be stored in the same vector object or may be stored separately.

In an embodiment, an embedding model is loaded directly into memory of database system 100 as a first-class object, which means it is a native object. An example format of the embedding model is ONNX (Open Neural Network Exchange). A native object, the embedding model may be named, called, and dropped. Furthermore, permissions to the embedding model may be granted to users, groups of users, and/or organizations. Thus, vectorizer 140 may call or invoke the embedding model, passing a chunk of text as input, and receive an embedding as output of the call.

In an alternative embodiment, vectorizer 140 makes a third-party call to a remote provider, such as OpenAI and OCIGenAI, which implement the embedding model. An example of a third-party call is a REST API call to one of these remote providers. Alternatively, vectorizer 140 makes a local API call (e.g., a REST API call) to a locally-installed provider, such as Ollama, that implements an embedding model.

Vectorizer 140 (or another component of database system 100) stores vectors in a vector table 162, which is data structure that is a part of hybrid index 160. Though hybrid index 160 comprises multiple data structures, hybrid index 160 is presented to users thereof a single point of contact, a single interface to efficiently access data that is stored in vector form and in textual form. The interface is described in more detail herein.

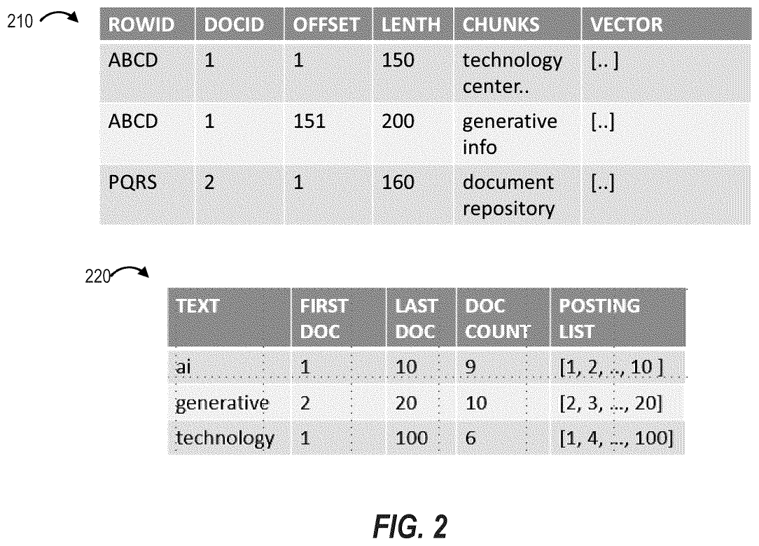

Vector table 162 includes multiple rows, one for each vector. FIG. 2 is a block diagram that depicts an example vector table 210 that is produced by vectorizer 140 (or another component of database system 100), in an embodiment. Vector table 210 includes a vector column that stores vectors. In this example, other columns of vector table 210 include a column for document identifiers (IDs), a column for row IDs, a column for offsets, a column for lengths, and a column for chunks. A document ID uniquely identifies the document from which the corresponding vector originates. A row ID uniquely identifies a row in a table that stores the corresponding document. An offset value is an offset into the corresponding document where the beginning of the chunk of text that corresponds to the vector is found, and a length value is a length of that chunk of text. Different chunks may have different lengths. Each chunk that is stored in the chunk column is the input to an embedding model that generates the corresponding vector.

Hybrid index 160 may also contain a vector index 164 that database system 100 constructs based on vector table 162. Such construction may be performed in response to receiving a database statement to generate hybrid index 160. Vector index 164 allows vector searches to be performed faster. Without vector index 164, a semantic search would have to check every vector in vector table 162 and perform a distance operation for each vector, where the query vector (in a semantic search) is compared to each vector and a distance between the two is calculated. Example distance operations include cosine distance, dot distance, Euclidean distance, and Manhattan distance. Examples of vector index 164 include an IVF index and an HNSW index. With vector index 164, many distance operations are avoided since only a small subset of distance operations are performed in order to identify the “closest” vectors to a query vector. However, there is no guarantee that the “closest” vectors to a query vector are indeed the closest, which can only be guaranteed with an exhaustive search of vector table 162.

### Tokenizer

Tokenizer 150 generates tokens for each textual data item that it receives from filter 120. An example of tokenizing includes identifying keywords and storing keywords in a text table 166, which is another data structure that is part of hybrid index 160. Before storing keywords in text table 166, tokenizer 150 may perform one or more operations on words and/or phrases that it detects in a textual data item, such as stemming, lemmatization, making plural words singular, etc.

Tokenizer 150 may also identify sections within plaintext. Examples of sections include any text that is marked up, such as author, title, and custom tags.

FIG. 2 also depicts a text table 220, which corresponds to text table 166. Text table 220 is an inverted index. Text table 220 includes five columns, but may include more or less columns. The five columns are a text column that stores tokens or words, a first document column that stores document IDs, a last document column that also stores document IDs, a document count that stores numbers, and a posting list column that stores lists of documents IDs. A document ID in the first document column identifies the first document that includes the corresponding token. A document ID in the last document column identifies the last document that includes the corresponding token. A document count is the number of documents that contain the corresponding token. A list of documents IDs contains document IDs of documents that contain the corresponding token.

In an embodiment, tokenizer 150 (or another component of database system 100) generates a text index 168 that indexes the words or phrases in text table 166. An example of text index 168 is a B-tree index. Such generation may be performed in response to receiving a database statement to construct hybrid index 160.

### Querying the Hybrid Index

A query that targets hybrid index 160 is referred to as a “hybrid query.” From the perspective of a user that requests results of a hybrid query, hybrid index 160 is a monolithic data structure. The user may be unaware of the fact that hybrid index 160 comprises multiple data structures or that different sub-queries are generated based on a hybrid query in order to access those data structures.

In an embodiment, a user may specify different types of hybrid queries to query hybrid index 160. Query engine 170 is able to process different types of hybrid queries that may be received from different users or the same user. One type of hybrid query that may be submitted to query engine 170 is a SQL query. Another type of hybrid query that may be submitted to query engine 170 is a NOSQL query (e.g., JSON or XML) or a “low SQL” query that includes both SQL and non-SQL elements. An example of a low SQL hybrid query is the following:

```
select DBMS_HYBRID_VECTOR.SEARCH (
  json (
      ‘{ “hybrid_index_name”: “idx”,
          “search_text”: “C, Python, Database”
        }′
    )
from dual;
```

The first field in the json object “json” is “hybrid_index_name” and the value of that field is “idx.” Thus, the query is invoking the hybrid index, such as hybrid index 160. The second field in the json object is “search_text” and the value of that field is “C, Python, Database.” Thus, the query is asking for documents that contain these three tokens: C, Python, and Database.

### Search API Options

In an embodiment, query engine 170 provides one or more search API options that a hybrid query may specify. At least some of the search API options may be default options. In a related embodiment, a DDL statement to create a hybrid index specifies one or more search API options.

Example search API options include a scorer function, a fusion function, a return format, a top N count, a search text for semantic/vector search, a search mode for semantic/vector search, a score weight, a rank penalty, and an aggregator function for semantic/vector search.

Example return formats include JSON, XML, and plaintext. Values for top N count may be any positive integer. If a value over 1,000 is specified, then a prompt may be presented asking a user if the user intended that value.

Example search modes for vector search include document and chunk. For example, a user submits a request that document IDs (or the documents themselves) be returned as a result of a hybrid query. Thus, if a vector search results in five chunks and they are all part of the same document, then only a single document (or document ID) is returned as part of the vector search. As another example, a user submits a request that chunk IDs (or the chunks themselves) be returned as a result of a hybrid query. Again, a value for the search mode may be specified at query time or at hybrid index creation time, or may be a default value.

In an embodiment, a hybrid query may specify a text string for a vector search and a list of one or more words or phrases for a text search. Thus, vector table 162 and text table 166 may be searched with different search terms.

An aggregator function is used to identify which document(s) to return given multiple of chunks that are identified as a result of a vector search. Input to the aggregator function is a list of chunk scores. Examples of aggregator functions include maximum, median, and mean. Other aggregator functions are described herein. If a hybrid query does not specify an aggregator function, then a default aggregator function (e.g., maximum or another aggregation function described herein) may be used. Additional aggregator functions are described elsewhere herein.

In an embodiment, search results from a vector search are weighted differently than search results from a text search. These score weights may be specified through score weight options. For example, a score weight for a vector search may be two and a score weight for a text search may be one, meaning that results from the vector search will be weighted twice as much as a results from the text search.

A rank penalty is used in some rank formulas, such as reciprocal rank fusion formula (RRF), which is used to combine search results from multiple sources, such as text source and a vector source. In RRF, “reciprocal” refers to “1/rank.” Thus, the highest ranked result is 1/1, the second highest ranked result is 1/2, and so forth. With no penalties, the score of a document might be 1/text_rank+1/vector_rank. However, if one set of results are to be favored over the other set of results, then a penalty may be added to the denominator. For example, Final score=1/(text_rank+text_penalty)+1/(vector_rank+vector_penalty). If the text_penalty is set to 5 and the vector_penalty is set to 1, then this means that the contribution of the text ranking is penalized.

Another example search API option for text searches is a value that indicates whether only documents containing all specified tokens are to be returned from performing a text search or if documents containing only a strict subset of the specified tokens may be returned from performing the text search.

### Example Search API

The following is an example of a full search API. Other implementations may have more or less parameters.

```
dbms_hybrid_vector.search(
  json(
    ‘{ “hybrid_index_name” : “my_index”,
```

| “search_text” | : “query for text and vector sear”, | |
|---|---|---|
| “search_scorer” | : “rrf”, | |
| “search_fusion” | : “INTERSECT/ ...”, | |
| “vector”: | | |
| { | | |
| “search_text” | : “something”, | |
| “search_vector” | : “ [...] ”, | |
| “search_mode” | : “DOCUMENT/CHUNK”, | |
| “aggregator” | : “MAX/AVG/..”, | |
| “score_weight” | : 10 , | |
| “rank_penalty” | : 1 | |
| }, | | |
| “text”: | | |
| { | | |
| “contains” | : “about(cats)”, | |
| “scorer” | : ‘definescore, mergescore’ | // - contains syntax includes operators to control |

scoring

| | | |
|---|---|---|
| “paths” | : [“mypath.a.b.c”, “p.q.r”], | // - JSON paths |

| “score_weight” | : 1, |
|---|---|
| “rank_penalty” | : 5 |
| } | |
| “filter_by”: | // |
| { | |
| “user_name” | : [“eq”, 5,] |
| } | |
| “return”: | |
| { | |
| “topN” | : 10, |
| “values” | : [“rowid”, “chunk_text”,..], |
| “format” | : “JSON” |

}

```
    }’
  )
)
{ “title”: “dbms_hybrid_vector.search”,
  “description”: “hybrid search parameters”,
  “type” : “object”,
  “properties” : {
```

| “hybrid_index_name” | | : {“type” : “string” }, |
|---|---|---|
| “partition_name” | | : {“type” : “string” }, |
| “search_text” | | : {“type” : “string” }, |
| “search_scorer” | | : {“type” : “string”, “enum” : [ “RSF”, “RRF” ] }, |
| “search_fusion” | | : {“type” : “string”, “enum” : [ “UNION”, “INTERSECT”, |
| | | “TEXT_ONLY”, “VECTOR_ONLY”, “MINUS_TEXT”, |
| | | “MINUS_VECTOR” ] }, |
| “vector” | : {“type” : “object”, | |
| | “properties” : { | |
| | “search_text” | : {“type” : “string” }, |
| | “search_vector” | : {“type” : “string” }, |
| | “search_mode” | : {“type” : “string”, enum : [“DOCUMENT”, |
| | | “CHUNK” ] }, |
| | “score_weight” | : {“type” : “number”, “minimum” : 1 }, |
| | “rank_penalty” | : {“type” : “number”, “minimum” : 0 }, |
| | “aggregator” | : {“type” : “string”, enum : [“COUNT”, “SUM”, “MIN”, |
| | | “MAX”, “AVG”, “MEDIAN”, “BONUSMAX”, |
| | | “MAXAVGMED”, “WINAVG”, “ADJBOOST” ] } |
| | }, | |
| | “additionalProperties”: false | |
| | }, | |
| “text” | : {“type” : “object”, | |
| | “properties” : { | |
| | “contains” | : {“type” : “string” }, |
| | “score_weight” | : {“type” : “number”, “minimum” : 1 }, |
| | “rank_penalty” | : {“type” : “number”, “minimum” : 0 } |
| | }, | |
| | “additionalProperties”: false | |
| | }, | |
| “return” | : {“type” : “object”, | |
| | “properties” : { | |
| | “topN” | : {“type” : “integer”, “minimum” : 1 }, |
| | “format” | : {“type” : “string”, enum : [ “JSON”, “XML” ] }, |
| | “values” | : { “type”: “array”, “items”: { “type”: “string”, “enum”: |
| | | [“rowid”, “score”, “vector_score”, “text_score”, |
| | | “vector_rank”, “text_rank”, “chunk_text”, |
| | | “chunk_id”] } } |

```
      },
      “additionalProperties”: false
      }
```

```
  },
  “additionalProperties”: false,
  “required”: [ “hybrid_index_name” ]
}
```

In an embodiment, with the search API, database system 100 may accept at least four broad types of queries:
a. (1) a query with one or more keywords that will be used to issue both a vector query and a textual query (e.g., a search for “generative Al” in both a vector search and a text search at the same time), where the results of the two queries are combined (e.g., union or join) and the results are reranked;
b. (2) a query that includes (i) first input (provided as keywords or a pre-computed vector) for a vector query, and (ii) second input for the textual query, where the results of the two queries are combined (e.g., union, join) and the results are reranked (e.g., search for “stock fraud” in the vector search and search for “ABC corporation” in the text search);
c. (3) a text only query; and
d. (4) a vector only query.

### Sub-Query Generation and Processing

In an embodiment, given a query, query engine 170 generates multiple sub-queries, each sub-query targeting a different set of one or more data structures. For example, one sub-query targets vector table 162 and vector index 164, another sub-query targets text table 166 and text index 168, and another sub-query targets a column in a table, which may have existed prior to the generation of hybrid index 160.

For example, a sub-query targets text index 168 and text table 166. Given the words “ai” and “technology” as search terms in a hybrid query, query engine 170 uses text index 168 to identify an entry in text table 166 that has “ai” in the text column of text table 166 and then retrieves a list of document IDs from the posting list column of text table 166. Similarly, query engine 170 uses text index 168 to identify an entry in text table 166 that has “technology” in the text column of text table 166 and then retrieves a list of document IDs from the posting list column of text table 166. Thus, query engine 170 has two posting lists and performs an intersection to identify the documents that contain both “ai” and “technology.” If the posting lists are relatively long (e.g., hundreds of document IDs), then query engine 170 may leverage the first document and the last document columns of text table 166 (which columns may also be reflected in text index 168). Based on the respective document ID ranges of these two text search terms, query engine 170 may determine that the range of document IDs of one text search term does not overlap the range of document IDs of the other text search term. Therefore, query engine 170 may determine that the intersection of the two posting lists is zero, meaning no documents contain both text search terms. Thus, query engine 170 does not have to access the posting list of either text search term, much less perform a match between the two posting lists. This process of using the first document and last document columns may save significant time and computer resources.

Query engine 170 may also use the document count column when processing a sub-query. For example, if the document count associated with a token is relatively high, then a ranking of a result that is associated with the token may be relatively low. Conversely, if the document count associated with a token is relatively low, then a ranking of a result that is associated with the token may be relatively high.

Query engine 170 also causes one or more query vectors to be generated based on one or more search terms indicated in the hybrid query. The one or more search terms may be the same search terms that are used in the text sub-query (or “text search query” or “text search”). Alternatively, the one or more search terms for the vector sub-query (or “vector search query” or “vector search”) may be different than the one or more search terms that are used in the text-sub-query. Thus, a hybrid query may specify different search terms for each of two or more sub-queries. The one or more search terms of the vector sub-query are input to an embedding model, the same embedding model that was used by vectorizer 140 to generate the vectors. The embedding model outputs one or more query vectors, which become part of the vector sub-query.

Query engine 170 processes the sub-queries (e.g., by executing execution plans that are generated from the sub-queries), resulting in a result set for each sub-query. A result in a result set is a document identifier and/or a chunk identifier. Query engine 170 produces result data for each result (e.g., chunk) in the result set. Examples of result data for a result include a row ID of the corresponding document, an overall (hybrid) score of the result (whether a document or a chunk in the document), a vector score of the result, a text score of the result, vector rank of the result, a text rank of the result, and text of the chunk (if the result is a chunk).

Query engine 170 may combine the results from all the result sets into a single final result set and cause the final result set to be presented. Combining the results may involve consulting a mapping of document IDs to row IDs in order to obtain a set of row IDs given a final result set of document IDs. Each row ID uniquely identifies a row in a database table where the document is stored. Query engine 170 may then retrieve, for each row ID, the document that is stored in the row of that row ID.

### Execution Plan Processing

In an embodiment, query engine 170 generates multiple execution plans, each execution plan comprises multiple operations in order to generate a final result of a hybrid query. Each execution plan for a hybrid query may comprise a different set of operations. Two or more execution plans may comprise the same set of operations but in a different order. For example, one execution plan includes a set of sub-queries that are performed in one order and another execution plan includes the same set of sub-queries that are performed in a different order. For each execution plan, query engine 170 generates an estimated cost of executing that execution plan. The estimated cost may be in time or in computer resources (e.g., CPU, memory, disk I/O, network I/O, etc.) or a combination of the two. Query engine 170 selects the execution plan that is associated with the lowest estimated cost. If the selected execution plan results in an error during execution of that plan, then query engine 170 may select another execution plan that is associated with the next lowest estimated cost.

In a related embodiment involving intersection of the search results from different searches (e.g., a vector search and a text search), query engine 170 determines a selectivity of each subquery of multiple sub-queries. The selectivity of each sub-query may determine which sub-query is performed first. Thus, instead of performing multiple sub-queries of a hybrid query in parallel, at least two sub-queries may be performed sequentially, where the result set of a first sub-query is used to execute a second sub-query.

For example, if a hybrid query includes one or more search terms that are very unique (meaning a text search query will result in very few results), then query engine 170 may determine to perform the text search query before a vector search query (and, optionally, before a relational search query, if one exists). With relatively few document IDs that are returned as a result of the text search query, those document IDs are used while performing the vector search query. For example, before performing a distance operation between a query vector and a candidate vector in vector index 168, query engine 170 identifies a document ID of the candidate vector and determines whether that document ID is found in the result set of the text search query. If not, then the distance operation is avoided and another candidate vector is considered.

As another example, if a hybrid query is associated with a top N parameter value that is less than a particular value (e.g., five), then query engine 170 determines to perform a vector search query first to identify the, for example, five chunk IDs and determine the corresponding document IDs, which may be less than five. This determination may be also based on determining that the text search query is not very selective, meaning that relatively many document IDs are estimated to be returned based on the text search query. After identifying the five or fewer document IDs from the vector search query, those document IDs are used to reduce the document IDs that are considered while performing the text search query.

### Example Scorer Functions

As noted herein, another search API option is a scorer function. Example scorer functions that may be specified as a search API option include relative score fusion (RSF) and reciprocal rank fusion (RRF). In an embodiment, query engine 170 (or a component thereof) implements one or both of RSF and RRF.

RSF is computed by dividing (a) the sum of (i) the product of the vector score and the vector weight and (ii) the product of the text score and the text weight by (b) the sum of the vector weight and the text weight. A formula for RSF this is as follows:

RSF=((text_score*text_weight)+(vector_score*vector_weight))/(text_weight+vector_weight)

RRF is computed by computing an RRF value (RRFVAL) and an RRF max value (RRFMAX), taking the ratio, and multiplying by one hundred. A formula for RRF is as follows:

$$RRFVAL = 1 / ( rank + penalty ) + 1 / ( rank + penalty )$$

$$RRF MAX = 1 / ( 1 + 5 ) + 1 / ( 1 + 1 )$$

$$RRF = 100 * ( RRFVAL / RRF MAX )$$

The ‘5’ and the last ‘1’ are values for rank penalties, which may be default values or values that have been set in a search API call of a query. The other values are pre-defined.

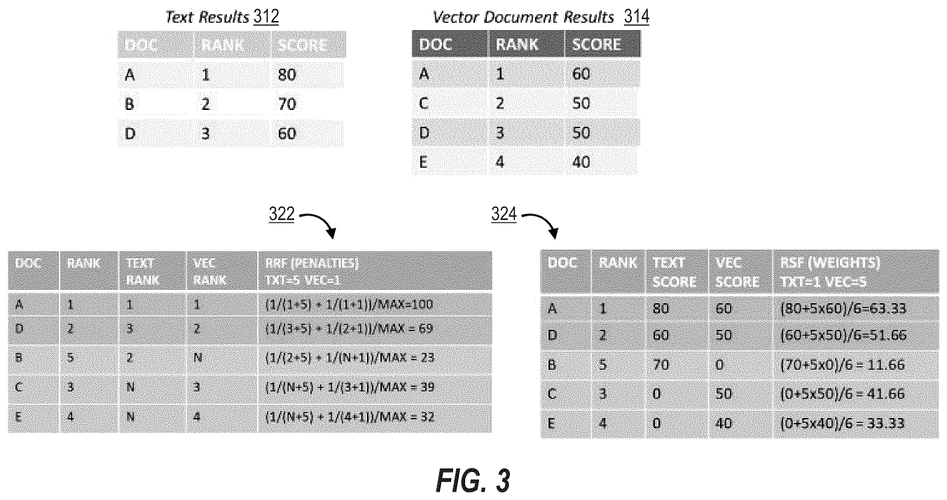

FIG. 3 depicts examples of two different final sets of results given a result set 312 from performing a text search of hybrid index 160 and a result set 314 from performing a vector search of hybrid index 160. Each “intermediate” result set is based on the same single query that query engine 170 receives.

Result set 312 may be combined with result set 314 using RRF to generate a final result set 322. Additionally or alternatively, result set 312 may be combined with result set 314 using RSF to generate a final result set 324.

### Example Fusion Functions

Example fusion functions include intersect, union and minus. The intersect function returns documents that appeared in the vector search results and in the text search results. In contrast, the union function returns documents that appeared in either search results. The minus function either returns all results in the vector search results that did not appear in the text search results or all results in the text search results that did not appear in the vector search results. If minus is a selected fusion function, then a user may specify in a hybrid query which search results will be subtracted from.

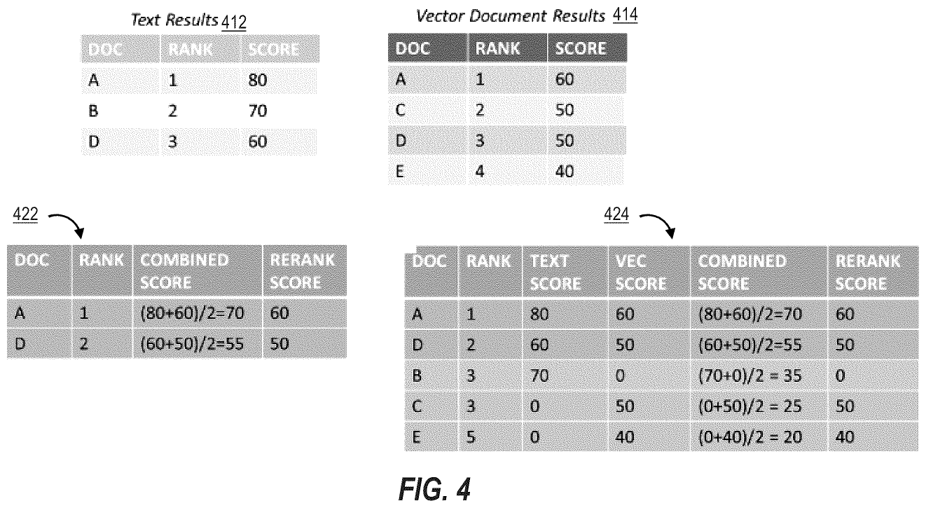

FIG. 4 depicts examples of two different final sets of results given a result set 412 from performing a text search of hybrid index 160 and a result set 414 from performing a vector search of hybrid index 160. Each “intermediate” result set is based on the same single query that query engine 170 receives.

Result set 412 may be combined with result set 414 using the intersect function to generate a final result set 422. Additionally or alternatively, result set 412 may be combined with result set 414 using union to generate a final result set 424, which includes all the results from result set 412 and from result set 414.

In this example, the rerank score is the vector score, whereas the combined score is a weighted sum of the vector score and the text score. In this example, the vector score and the text score are weighted equally in the combined score. However, in other implementations, the weighting may be different.

### Aggregating Chunk Scores

When performing a semantic search that seeks to return documents instead of chunks, then a document may be identified that is associated with multiple chunks for which scores were generated. Examples of aggregation operations that may be performed on multiple chunk scores to generate a single document score include maximum, average, and median. However, each aggregation operation has its drawbacks. For example, identifying a maximum chunk score and using that maximum chunk score may result in a large document that only has a single chunk that is relevant while all other chunks in the large document are irrelevant. In this example, it would be preferable to select a different document that is associated with multiple chunks that have slightly lower scores than the maximum chunk score.

In an embodiment, a document score is generated for a document based on scores of multiple chunks that are physically close to each other in the document. There are two main methods: the window average method and the adjustment boost method.

In the window average method, a maximum average of a rolling window is determined. First, the top N (e.g., ten) chunk scores of a document are identified. For each “window” of chunks (of the chunks that are identified), an average chunk score is computed for the chunks in that window. Depending on the number of chunks and the size of the window, one or more average chunk scores are generated. If there are multiple average chunk scores, then the maximum average chunk score is selected as the aggregated score for the document.

For example, if the chunks of a document that are identified based on executing a vector query are 2, 8, 10, and 19 and the window size is three, then the windows of chunks are {2, 8, 10} and {8, 10, 19}. From these two sets of chunks, an average of the chunk scores in each set is computed and the maximum average is selected as the aggregated score for the document.

In the adjustment boost method, the average boosted chunk score is computed for the top N (e.g., five) chunks. The maximum boost for each chunk is M minus the chunk score. An example value for M is one hundred. Each of N chunk scores is increased with its maximum boost multiplied by the average score of the surrounding chunks' scores. A formula for computing the adjustment boost (ADJBOOST) for a document is as follows:

$${BOOSTSCORE}_{i} = {CHUNKSCORE}_{i} + ( M - {CHUNKSCORE}_{i} ) * ( ( {PRIORSCORE}_{i} + {NEXTSCORE}_{i} ) / 2 M ) // \\ this is computed for each ( i ) chunk of the top N chunks$$

$$ADJBOOST = SUM ( {boostscore}_{1} , … , {boostscore}_{N} ) / N$$

Thus, if a particular chunk is surrounded by two chunks that are not scored, then the boost score for that particular chunk is the chunk score of that particular chunk. Therefore, if none of the N chunks that are returned as part of a vector search has an adjacent chunk that is also part of the N chunks, then the ADJBOOST is a simple average of the N chunk scores.

### Example Process

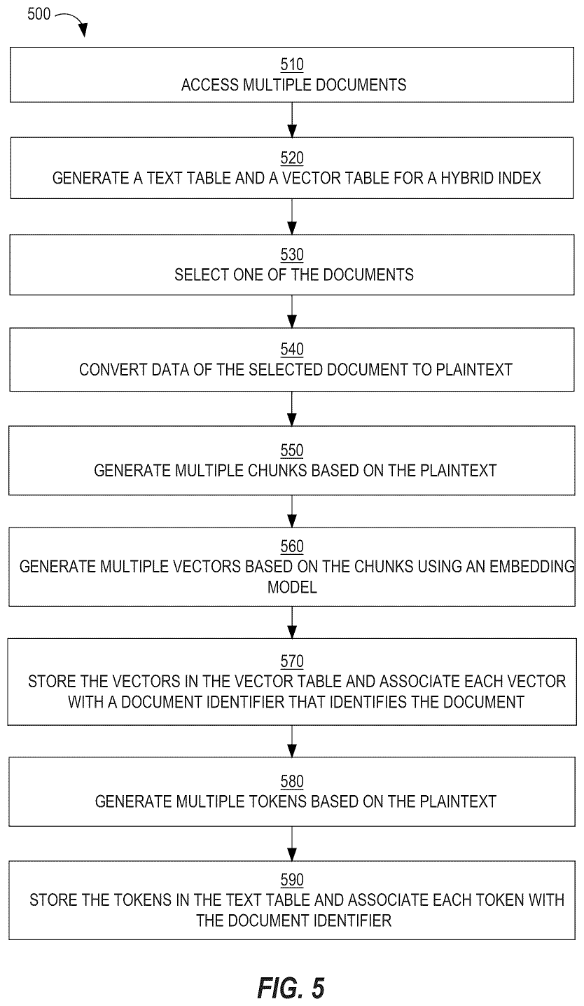

FIG. 5 is a flow diagram that depicts an example process 500 for processing a hybrid query in an embodiment.

At block 510, multiple documents are accessed. The documents may be stored in data source 110. Some or all of those documents may originate from one or more remote data sources. The accessed documents may be of different types, such as PDF and Word. Also, some accessed documents may be from one column data type (e.g., JSON) while other accessed documents may be from another column data type (e.g., text). Block 510 may be initiated by a database statement that instructs database system 100 to create a hybrid index.

At block 520, a vector table and a text table are generated. Block 520 may be performed before block 530 or some time later. Initially, the vector table and the text table are empty.

At block 530, a document is selected. Block 530 may involve a random selection from the accessed documents or may involve selecting the accessed documents in a particular order. The document selected in one iteration of block 530 may be different than the document selected in another iteration of block 530. Block 530 may be performed by filter 120.

At block 540 data with the selected document is converted to plaintext. Block 540 may be performed by filter 120. Block 540 may involve determining the type of the selected document and determining one or more conversion operations that are associated with that type. Thus, conversion operations may include decoding the data, transforming the data, and/or unzipping zipped data, etc. Thus, depending on the type of document, a different set of one or more conversion operations to generate the plaintext may be performed. Block 540 may also involve filter 120 transmitting the plaintext to chunker 130.

At block 550, multiple chunks are generated based on the plaintext. Block 550 may be performed by chunker 130. The specific type of chunking may be a default type or may be specified in the database statement that initiated creation of the hybrid index.

At block 560, an embedding model generates multiple vectors based on the generated chunks. In other words, the embedding model generates a vector for each chunk. Block 560 may be initiated by vectorizer 140 invoking the embedding model.

At block 570, the vectors are stored in the vector table along with a document identifier (that identifies the selected document from which the corresponding chunk originates) in association with each of the vectors. Each vector is stored in a different row of the vector table. Block 570 may be performed by vectorizer 140 or another component of database system 100.

At block 580, multiple tokens are generated based on the plaintext. Block 580 may be performed by tokenizer 150.

At block 590, the tokens are stored in the text table along with the document identifier in association with each of the tokens. Each token is stored in a different row of the text table. Block 590 may also be performed by tokenizer 150.

Process 500 may also involve generating a vector index on the vector table and a text index on the text table.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

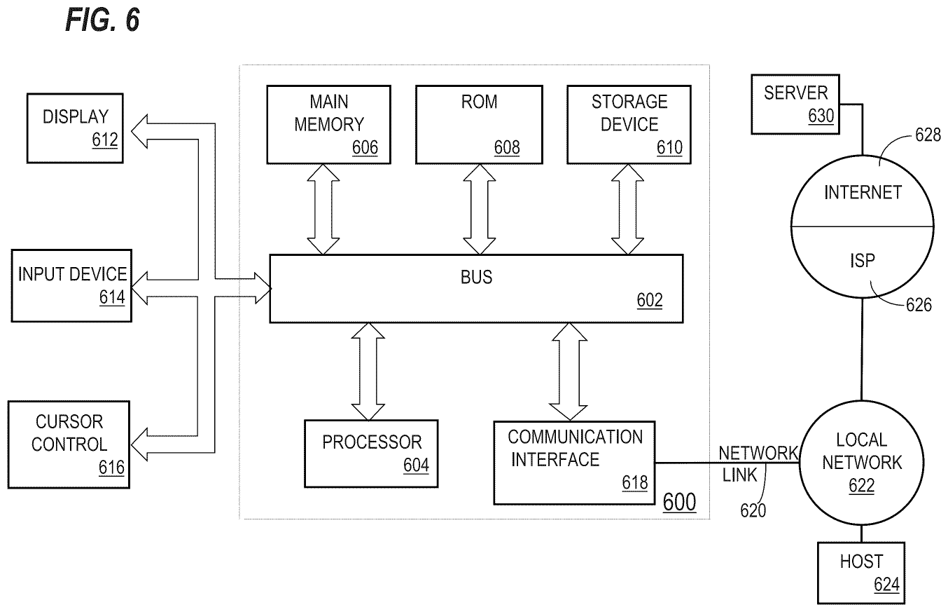

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

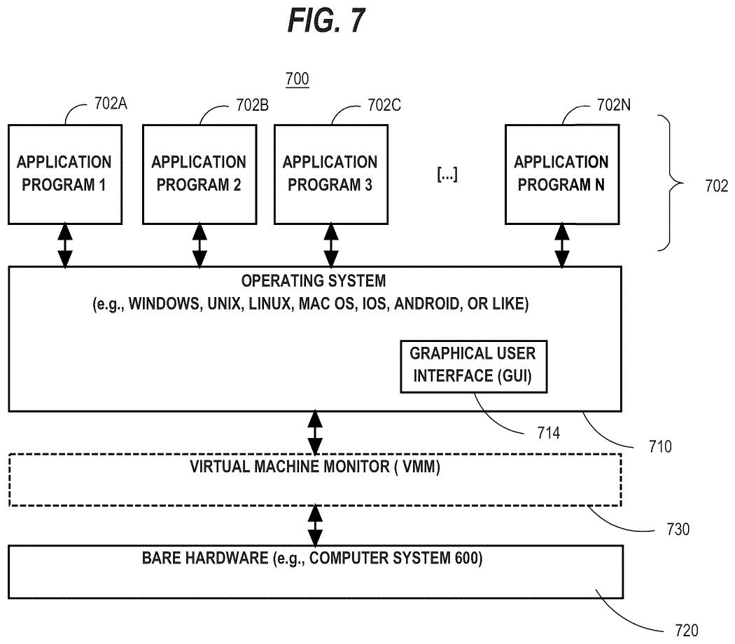

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method performed within a database system comprising:
accessing a plurality of documents;
generating a vector table and a text table;
for each document of the plurality of documents:
converting data within said each document to plaintext;
generating a plurality of chunks based on the plaintext;
generating, by an embedding model, a plurality of vectors based on the plurality of chunks;
storing the plurality of vectors in the vector table;
storing, in the vector table, a document identifier, that identifies said each document, in association with each vector of the plurality of vectors;
generating a plurality of tokens based on the plaintext;
storing the plurality of tokens in the text table;
storing, in the text table, the document identifier in association with each token of the plurality of tokens;
wherein the method is performed by one or more computing devices.

2. The method of claim 1, wherein:
the plurality of documents comprise a first document of a first type and a second document of a second type that is different than the first type;
converting the data with said each document comprises:
for the first document of the plurality of documents, performing a first conversion operation on the first document based on the first document being of the first type;
for the second document of the plurality of documents, performing a second conversion operation on the second document based on the second document being of the second type.

3. The method of claim 1, further comprising:
receiving a database statement that instructs a database system to create a hybrid index;
wherein generating the vector table and the text table is performed in response to receiving the database statement.

4. The method of claim 3, further comprising:
generating a vector index on the vector table in response to receiving the database statement;
generating a text index on the text table in response to receiving the database statement.

5. The method of claim 3, wherein the database statement indicates the embedding model.

6. The method of claim 3, wherein the database statement indicates a type of vector index, the method further comprising:
generating the type of vector index in response to receiving the database statement.

7. The method of claim 3, wherein the database statement indicates a technique for chunking the plaintext, wherein generating the plurality of chunks is performed using the technique.

8. The method of claim 3, wherein the database statement indicates a distance operation for computing a distance between two vectors.

9. The method of claim 1, further comprising:
receiving a hybrid query that indicates one or more search terms;
generating one or more query vectors based on the one or more search terms;
identifying, based on the one or more query vectors, one or more document identifiers from the vector table.

10. The method of claim 9, wherein the one or more search terms are one or more first search terms, the method further comprising:
in response to receiving the hybrid query, generating a text query that includes one or more second search terms, wherein the one or more second search terms are either (i) one or more of the one or more first search terms or (ii) different than the one or more first search terms;
executing the text query, wherein executing the text query comprises identifying, based on the one or more second search terms, one or more second document identifiers from the text table.

11. The method of claim 9, wherein the hybrid query is a first hybrid query, wherein the first hybrid query is a SQL query, the method further comprising:
receiving a second hybrid query that indicates the hybrid index, wherein the second hybrid query is a NOSQL query or a low SQL query.

12. The method of claim 9, further comprising:
using the one or more query vectors to identify a plurality of chunks in the vector table;
determining that two or more chunks in the plurality of chunks belong to a particular document of the plurality of documents;
for a first chunk of the two or more chunks:
identifying a first plurality of chunk scores of chunks that surround the first chunk;
generating, for the first chunk, a first adjustment score based on the first plurality of chunk scores and a first chunk score of the first chunk;
for a second chunk of the two or more chunks:
identifying a second plurality of chunk scores of chunks that surround the second chunk;
generating, for the second chunk, a second adjustment score based on the second plurality of chunk scores and a second chunk score of the second chunk;
determining a score for the particular document based on the first adjustment score and the second adjustment score.

13. The method of claim 9, further comprising:
using the one or more query vectors to identify a set of chunks in the vector table;
determining that a plurality of chunks in the set of chunks belong to a particular document of the plurality of documents;
identifying a window size that is less than the number of chunks in the plurality of chunks;
identifying a plurality of subsets of the plurality of chunks;
for each subset in the plurality of subsets:
generating an average score of chunks scores of chunks in said each subset;
adding the average score to a set of average scores;
identifying the maximum average score in the set of average scores;
associating the maximum average score with the particular document.

14. The method of claim 1, further comprising:
receiving a hybrid query that indicates one or more search terms;
in response to receiving the hybrid query, generating (1) a text sub-query that targets the text table and (2) a vector sub-query that targets the vector table;
executing the text sub-query to generate a first set of results;
executing the vector sub-query to generate a second set of results;
combining the first set of results with the second set of results to generate a final set of results.

15. The method of claim 14, wherein the first set of results is a first set of document identifiers, wherein the second set of results is a second set of document identifiers, wherein the final set of results is (i) a union of the first set of document identifiers and the second set of document identifiers or (ii) an intersection of the first set of document identifiers and the second set of document identifiers.

16. A method performed by a database system, comprising:
accessing a plurality of documents that comprises documents of different types;
for each document of the plurality of documents:
identifying a type of said each document;
selecting a conversion operation that corresponds to the type;
using the conversion operation to convert data within said each document to plaintext;
generating a vector index based on the plaintext;
generating a text index based on the plaintext;
wherein the method is performed by one or more computing devices.

17. One or more non-transitory storage media storing instructions which, when executed by one or more computing devices of a database system, cause:
accessing a plurality of documents;
generating a vector table and a text table;
for each document of the plurality of documents:
converting data within said each document to plaintext;
generating a plurality of chunks based on the plaintext;
generating, by an embedding model, a plurality of vectors based on the plurality of chunks;
storing the plurality of vectors in the vector table;
storing, in the vector table, a document identifier, that identifies said each document, in association with each vector of the plurality of vectors;
generating a plurality of tokens based on the plaintext;
storing the plurality of tokens in the text table;
storing, in the text table, the document identifier in association with each token of the plurality of tokens.

18. The one or more storage media of claim 17, wherein:
the plurality of documents comprise a first document of a first type and a second document of a second type that is different than the first type;
converting the data with said each document comprises:
for the first document of the plurality of documents, performing a first conversion operation on the first document based on the first document being of the first type;
for the second document of the plurality of documents, performing a second conversion operation on the second document based on the second document being of the second type.

19. The one or more storage media of claim 17, wherein instructions which, when executed by the one or more computing devices, further cause:
receiving a database statement that instructs a database system to create a hybrid index;
wherein generating the vector table and the text table is performed in response to receiving the database statement.

20. The one or more storage media of claim 19, wherein instructions which, when executed by the one or more computing devices, further cause:
generating a vector index on the vector table in response to receiving the database statement;
generating a text index on the text table in response to receiving the database statement.
